(19) United States
(12) Patent Application Publication
(10) Pub. No.: US 2004/0236855 A1
(43) Pub. Date: Nov. 25, 2004

(54) Multi-link tunneling

(76) Inventor: Amir Peles, Tel Aviv (IL)

Correspondence Address: KATTEN MUCHIN ZAVIS ROSENMAN, 575 MADISON AVENUE, NEW YORK, NY, 10022-2585, US

(21) Appl. No.: 10/728,236

(22) Filed: Dec. 3, 2003

Related U.S. Application Data
(60) Provisional application No. 60/473,177, filed on May 23, 2003.

(51) Int. Cl. G06F 15/16

(52) U.S. Cl. 709/227; 709/245

(57) ABSTRACT

A multi-homing tunneling device is used to transmit packets received from a station (in a first business site) to another remote station (in a second business site) via a tunnel formed between a link in the first business site and a link in the second business site. Different external addresses are used on every link to represent internal addresses. Mappings between various internal and external addresses are stored in the tunneling device. Further, tunneling devices are able to communicate with each other to exchange such mappings. The original content is reconstructed based upon such mappings.

### CROSS-REFERENCE TO RELATED APPLICATION

The present application hereby claims priority from Provisional Application No. 60/473,177 which was filed on May 23, 2003.

### BACKGROUND OF THE INVENTION

1. Field of Invention

The present invention relates generally to the field of network communications. More specifically, the present invention is related to network communications over multiple links.

2. Discussion of Prior Art

Business enterprises with multiple office locations use the Internet as a popular means for communicating between such locations. Generally, business-oriented communications require fast connectivity, guaranteed (and often large) bandwidth, high security level (for sensitive information), and high availability.

The continuing need for increases in speed and bandwidth of a network are met as long as the backbone networks are able to grow to accommodate such a need. With regard to the high security level, many enterprises utilize virtual private network (VPN) techniques and advanced encryption mechanisms to allow for the secure transfer of data over the Internet. To ensure availability of the Internet, enterprises use a multi-homing technique wherein a network (or networks) associated with the enterprise is connected to the Internet Service Provider (ISP) via multiple links. Such multiple links may connect to the same or different ISPs at different access point and at different locations.

Managing multiple links from an office brings out multiple challenges. Each link has a different capacity, different price, and different performance in relation to the flow of traffic (inbound or outbound). Hence, it is important to use such multiple links in the most efficient way and get the best response time for the best price. Furthermore, in a scenario wherein an organization has multiple offices spread across the Internet, each office has its internal network and connects to the external shared network through a single or multiple links. This setup provides multiple options for passing traffic between offices, and requires a smart system to manage the flow of traffic appropriately such that the traffic will enjoy the optimal combination of response time, security, high availability, and pricing.

The traffic which flows across the multiple networks includes many business-oriented applications, each of them having different content that needs to be transmitted over the network. Developing these applications is a time consuming process and involves many computing components in the internal office networks. Hence, an important consideration in current enterprise networking systems (using such multiple links) is that they require additional development and awareness with respect to the business equipment. Therefore, a multi-link communication session would be beneficial if such a session, in addition to the requirements of managing the flow of the traffic, could also be transparent to the applications which flow across the networks.

Whatever the precise merits, features, and advantages of the above-mentioned prior art systems, none of them achieve or fulfills the purposes of the present invention.

### SUMMARY OF THE INVENTION

The present invention provides for a method and device implementing multi-link tunneling. The method, as implemented in a multi-homing tunneling device (wherein the device is associated with a plurality of stations in a first site), facilitates tunnel-based packetized transmission from a first station (in the first site) to a second station (in a second site) via one or more links communicating with one or more networks. The first station has a first station address (associated with an internal network of the first site) and the second station has a second station address (associated with an internal network of the second site).

The method comprises the steps of: (a) receiving a first packet (among a plurality of packets) from the first station, wherein the first packet identifies, as a source address, the first station address, and identifies, as a destination address, the second station address; (b) selecting, for transmission of the packet, a tunnel among a plurality of available tunnels between the first and second site, wherein each of the tunnels is formed between a single link in the first site and a single link in the second site; (c) based on the selected tunnel in (b), identifying a source tunnel address associated with the source address and identifying a destination tunnel address associated with the destination address; (d) modifying the packet by replacing the source address and the destination address of the packet with the source tunnel address and destination tunnel address, respectively; (e) transmitting the modified packet through a link corresponding to the selected tunnel; and (f) repeating steps (a)-(e) for transmitting each of the remainder packets.

As the traffic between the first station and the second station is bi-directional, the present invention's method also encompasses the flow of data from the tunnels to a multi-homing tunneling device associated with the first site. Such a method comprises the steps of: (a) receiving a packet over a link, wherein the destination address is a tunnel address of the first site and the source address is a tunnel address of the second site; (b) identifying an address of a first station in the first site and an address of a second station in the second site, both associated with the tunnel addresses of the packet; (c) modifying the packet by replacing the destination address and the source address of the packet with the address of the first station and second station respectively; and (d) transmitting the modified packet to the first station.

The present invention's multi-homing tunneling device (located at a first site) facilitates tunnel-based packetized communication transmission between a first station in a first site and a second station in a second site, wherein the communication is performed over one or more external networks. The device comprises: (a) a first interface operatively linking the device with a plurality of stations in the first site; (b) a second interface operatively linking the device with one or more external networks via a plurality of links, wherein the device is able to communicate, over external networks, with a plurality of stations on a second site via a plurality of tunnels, and each of the tunnels are formed between a single link in the first site and a single link in the second site; and (c) memory for storing network information associated with the tunnels and the stations.

The multi-homing tunneling device receives packets, via said first interface (for transmission from a station in the first site), identifies available tunnels in memory for transmitting the received packets, modifies the received packets based upon the identified tunnels, and transmits (via said second interface) the modified packets over external networks to destination stations. The multi-homing tunneling device associated with the first site is also able to receive packets (transmitted from a station in a second site) via the second interface over one or more links. The device, upon reception of such data, identifies an address of a first station (intended recipient) in the first site and an address of a second station (source) in the second site (both associated with the tunnel addresses of the packet), modifies the packet by replacing the destination address and the source address of the packet with the address of the first station and second station respectively, and transmits the modified packet to the first station.

### BRIEF DESCRIPTION OF THE DRAWINGS

FIG. 1 illustrates an example of a multi-service, multi-site, multi-homed system based upon the present invention.

FIG. 2 illustrates an example of two sites that connect to an external network through the present invention's multi-homing tunneling device.

FIG. 3 illustrates an example showing the present invention's multi-homing tunneling device that connects to an external network via two links.

FIG. 4 illustrates a flowchart depicting a method associated with an embodiment of the present invention.

FIG. 5 illustrates the transmission of a packet via the present invention's multi-homing device.

FIG. 6 illustrates a connection table where the present invention's multi-homing device stores information about a selected tunnel.

FIG. 7 illustrates the reception of a packet by the present invention's multi-homing device.

FIG. 8 illustrates the packet information modified by the present invention's multi-homing device.

### DESCRIPTION OF THE PREFERRED EMBODIMENTS

While this invention is illustrated and described in a preferred embodiment, the invention may be produced in many different configurations, forms and materials. There is depicted in the drawings, and will herein be described in detail, a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the present invention.

The present invention provides for a method and system to manage multi-homed access from various sites (e.g., business) across a network, via a multi-tunneling device. The multi-homing tunneling device, located at each site, monitors and manages traffic that flows from an internal network, associated with the site, to an external network. The multi-tunneling device also monitors and manages traffic that comes from the external network to the internal network. It should be noted that the present invention's multi-homing tunneling device is referred throughout the specification and accompanying figures as a “device”.

There exist multiple applications that require communication between various sites associated with an enterprise. One such application is a VPN that encrypts the traffic going to the external network and decrypts traffic arriving from the external network. Such an example of an application is referred throughout the specification as a “service”. For each service, there may be several nodes in each site that operate this service and communicate with nodes in other remote sites. These nodes are referred to throughout the specification as “stations”. There can be multiple services and multiple stations associated with each site. Two stations in two different sites can communicate between themselves. An instance of such communication is referred throughout the specification as a “connection”.

The present invention's device provides sites with external access to networks using multiple links. In one embodiment, the Border Gateway Protocol (BGP) is used to announce the internal addresses associated with various interfaces, such that an external network learns that multiple paths exist to access the internal network. The preferred embodiment involves the use of different addresses over different links, wherein the internal address to an external address is translated according to the specific link that the traffic of the internal address goes through.

Unlike the prior art, the present invention provides for a multi-homing solution that is transparent to applications. When using a protocol such as BGP, transparency is guaranteed since the internal address is also known as an external address and transmitting traffic doesn't require any modifications. When using a different external address on every link to represent the internal address, traffic must be modified when it is transmitted to a remote office. However, the original content must be reconstructed when receiving the information at the remote site. In the preferred embodiment, tunnels are used to solve this problem, wherein the traffic associated with business applications is encapsulated inside an envelope that routes the traffic from one office to another. The traffic is decapsulated back in the remote office such that the original information is sent to the business application.

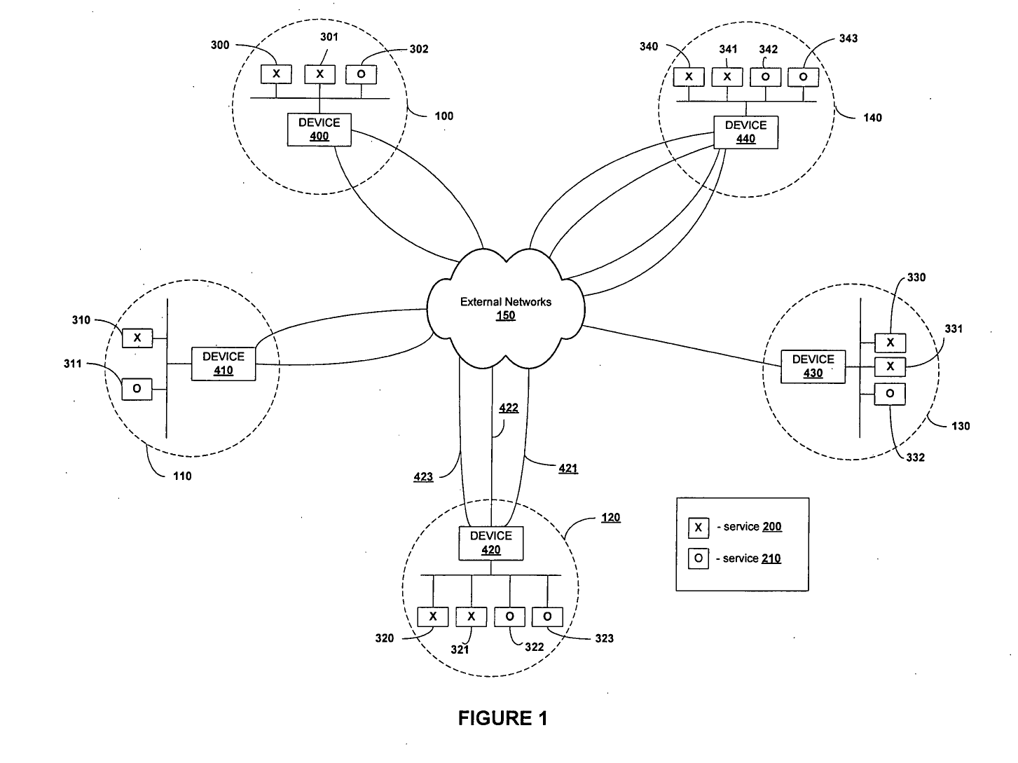

FIG. 1 depicts an example of a multi-service, multi-site, multi-homed system based upon the present invention. Sites 100, 110, 120, 130 and 140 are connected to each other through one or more external network(s) 150. Although only one network cloud is shown in FIG. 1 to represent an external network via which network traffic travels between sites, it should be noted that the system and method of the present invention can work in conjunction with a plurality of networks.

Each site includes one or more stations that operate one or more services. In this specific example, services offered are shown as “x” 200 and “o” 210. In site 100, stations 300 and 301 operate service 200 and station 302 operate service 210. Similarly, in site 110, station 310 operates service 200 and station 311 operates service 210. The present invention's multi-homing tunneling device 400, 410, 420, 430 and 440 is located at each site. Each device manages the traffic between the sites and has a single link, or multiple links, that connects it to external network 150. Multiple links are shown, for example, as 421, 422, and 423 from device 420 to external networks 150. Similarly, devices 400, 410, 430, and 440 also have similar links which can range from one link to a plurality of links.

Each link from each site to external network 150 is associated with a range of external IP addresses. Traffic that comes from external network 150 addresses an IP address that belongs to one of these ranges. Therefore, traffic can reach a site, through a link using an IP address that belongs to the range associated with that particular link. A tunnel, as used in the specification, refers to a combination of a single link in a first site and a single link in a second site, wherein the tunnel is used for passing traffic between the sites.

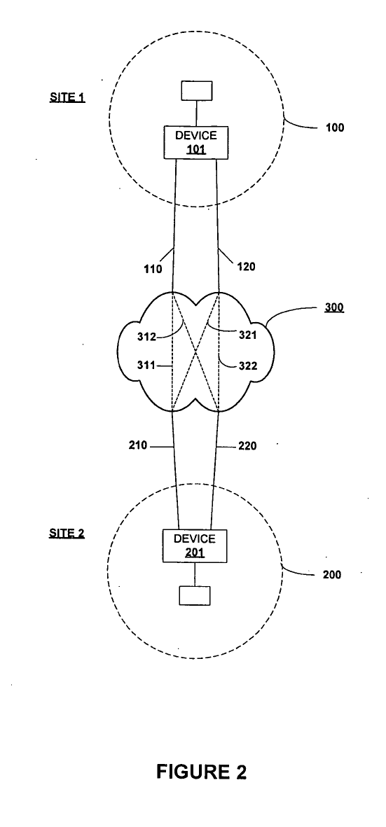

FIG. 2 depicts an example showing two sites 100 and 200 that connect to external network 300 through the present invention's multi-homing tunneling devices 101 and 201. Site 100 has two links, 110 and 120, and site 200 has two links, 210 and 220. Link 110 from site 100 and link 210 from site 200 create tunnel 311. Link 110 from site 100 and link 220 from site 200 create tunnel 312. Similarly, link 120 from site 100 and link 210 from site 200 create tunnel 321, and link 120 from site 100 and link 220 from site 200 create tunnel 322.

Each station has an IP address on the internal network—called the station address, and an IP address that is associated with the station and each of the external network links—called the tunnel address. A station address and a tunnel address can also be composed from combinations of an IP address value, a TCP port number, a UDP port number, an IP protocol, an Ethernet tag, a MPLS tag, and other header field values. It should also be noted that a tunnel address can be similar to the station address.

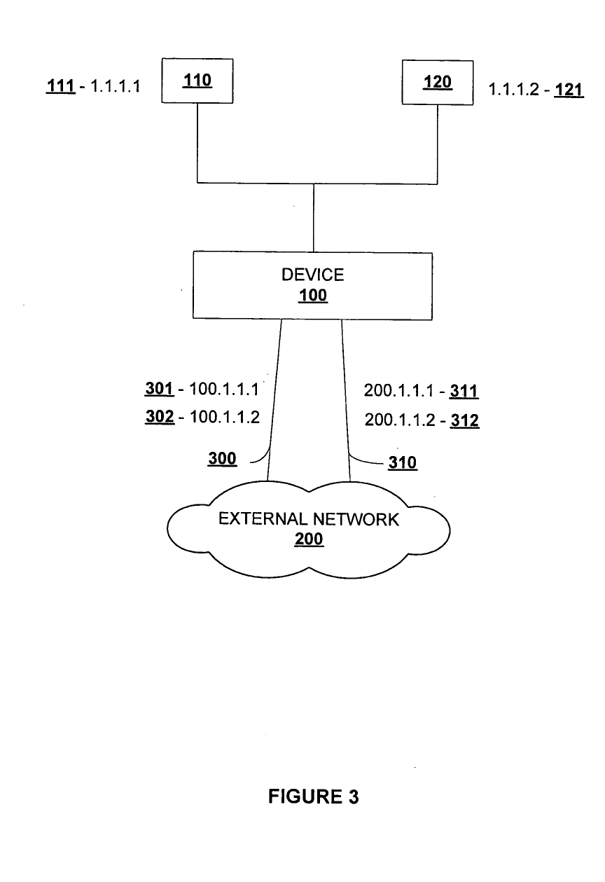

FIG. 3 illustrates an example showing the present invention's multi-homing tunneling device 100 in a site that connects to external network 200 through two links 300 and 310. The site of FIG. 3 has two stations 110 and 120. Station 110 has station address 111 (i.e., 1.1.1.1) and station 120 has station address 121 (i.e., 1.1.1.2). When transmitting or receiving traffic from external network 200 on link 300, station address 111 (i.e., 1.1.1.1) is represented by tunnel address 301. When transmitting or receiving traffic from external network 200 on link 310, station addresses 111 (i.e., 1.1.1.1) and 121 (i.e., 1.1.1.2) are represented by tunnel addresses 311 (i.e., 200.1.1.1) and 312 (i.e., 200.1.1.2) respectively. Similarly, when transmitting or receiving traffic from external network 200 on link 300, station addresses 111 (i.e., 1.1.1.1) and 121 (i e., 1.1.1.2) are represented by tunnel addresses 301 (i.e., 100.1.1.1) and 302 (i.e., 100.1.1.2).

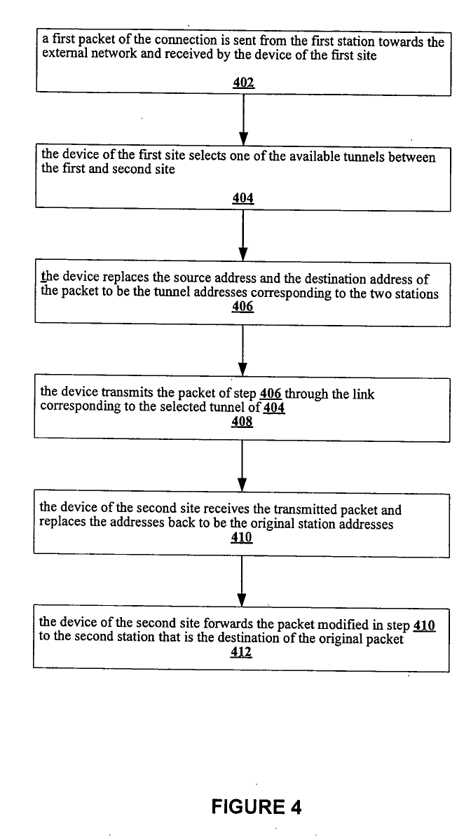

FIG. 4 illustrates a flowchart depicting a method 400 associated with one embodiment of the present invention. Whenever a first station in a first site starts a connection with a second station in a second site, the following steps take place:

(a) a first packet of the connection is sent from the first station towards the external network and received by the device of the first site—step 402;

(b) the device of the first site selects, for transmission of the packet, one of the available tunnels between the first and second site—step 404;

(c) based on the tunnel selection in (b), the device replaces the source address and the destination address of the packet to be the tunnel addresses corresponding to the two stations —step 406;

(d) the device transmits the packet of (c) through a link corresponding to the selected tunnel of (b)— step 408; (e) the device of the second site receives the transmitted packet and recognizes the source address to be associated with the tunnel address in the first site and the destination address to be associated with the tunnel address in the second site, and replaces the addresses back to be the original station addresses—step 410; and

(f) the device of the second site forwards the packet modified in (e) to the second station that is the destination of the original packet—step 412.

A detailed description of steps (a)-(f) described above is provided below from a system perspective.

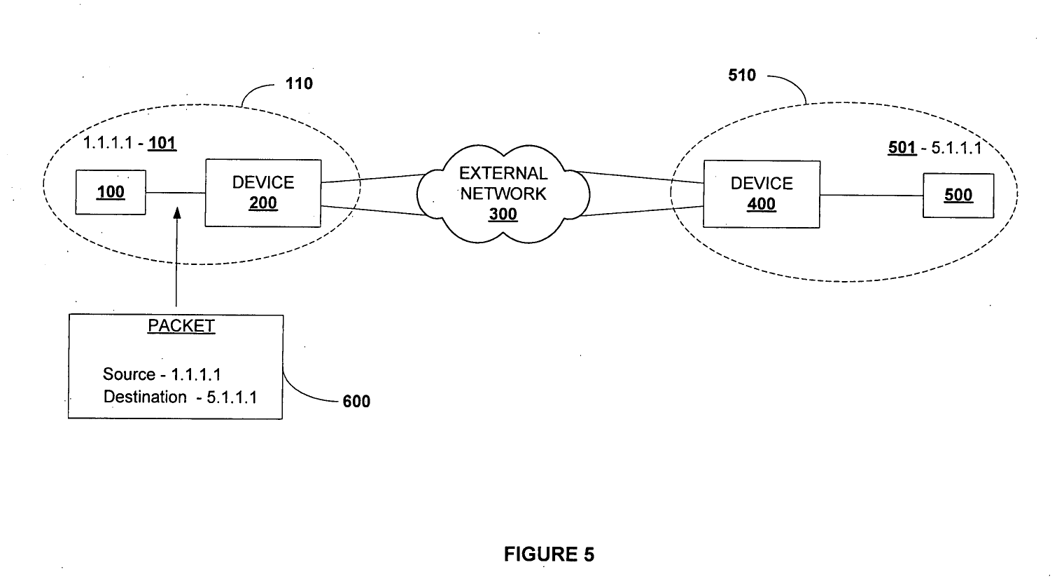

FIG. 5 illustrates a first packet 600 (of step 402 in FIG. 4) being sent from first station 100 towards external network 300, via device 200 of first site 110. More specifically, packet 600 is transmitted from first station 100 to second station 500 in second site 510. The source address of packet 600 is station address 101 (i.e., 1.1.1.1) that represents station 100 and the destination address of packet 600 is station address 501 (i.e., 5.1.1.1) that represents station 500.

Device 200 of first site 110 recognizes the source address as an internal address (that belongs to the first station in first site 110) that takes part in a tunneled service, and the destination address as an external address (that belongs to the second station 500 in the second site 510) that takes part in the same service. Then, the device 200 selects one of the available tunnels between the first site 110 and second site 510. Then, device 200 finds the tunnel address of the first station address 101 (i.e., 1.1.1.1) for the selected tunnel, and the tunnel address of the second station address 501 (i.e., 5.1.1.1) for the selected tunnel. Tables 1 and 2, below, show the local station table and remote station table where device 200 looks up the station addresses and the tunnel addresses for the optional tunnels.

TABLE 1
LOCAL STATION TABLE

| Station | Tunnel | Tunnel Address |
|---|---|---|
| 1.1.1.1 | 12 | 100.1.1.1 |
| 1.1.1.1 | 21 | 200.1.1.1 |
| 1.1.1.1 | 22 | 200.1.1.1 |

TABLE 2
REMOTE STATION TABLE

| Station | Tunnel | Tunnel Address |
|---|---|---|
| 5.1.1.1 | 12 | 400.1.1.1 |
| 5.1.1.1 | 21 | 300.1.1.1 |
| 5.1.1.1 | 22 | 400.1.1.1 |

Next, device 200 replaces the source address (i.e., 1.1.1.1) of packet 600 and the destination address (i.e., 5.1.1.1) of packet 600 to be the tunnel addresses of the two stations accordingly. Device 200 keeps the information about the current connection between stations 100 and 500, as well as the selected tunnel, in its memory.

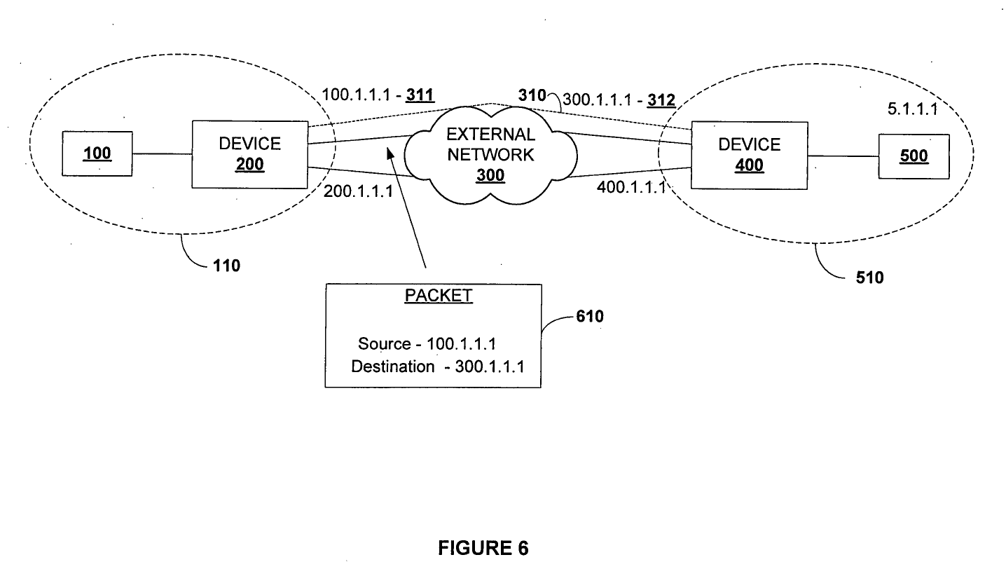

FIG. 6 illustrates connection table 230 where device 200 stores information about selected tunnel 310 used in the connection between stations 100 and 500. Packet 610 has the source address as tunnel address 311 (i.e., 100.1.1.1) of site 110 and destination address as tunnel address 312 (i.e., 300.1.1.1) of site 510.

Device 200 transmits the modified packet that carries the external addresses through the link that belongs to the selected tunnel in the first site. Then, the packet is forwarded through the external network to the link that belongs to the selected tunnel in the second site, as indicated by the modified destination address of the packet, where it is received by device 400 of the second site.

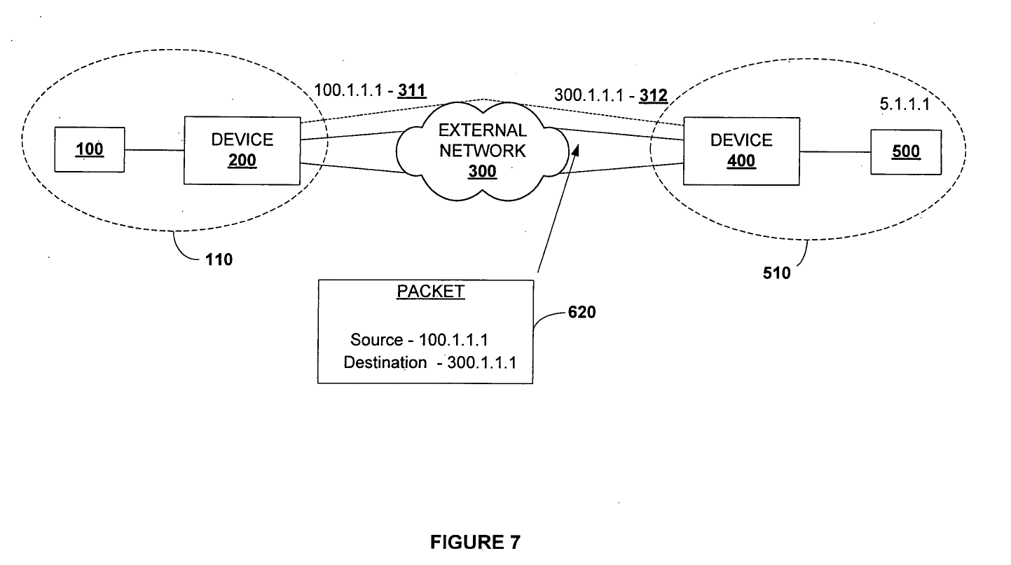

FIG. 7 shows packet 620 reaching device 400 in site 510 with source address as tunnel address 311 (i.e., 100.1.1.1) of site 110 and destination address as tunnel address 312 (i.e., 300.1.1.1) of site 510.

Next, device 400 of the second site recognizes the source address to be associated with the tunnel address in the first site and the destination address to be associated with the tunnel address in the second site. Then, device 400 replaces the addresses back to be the original station addresses, having the source address of the first station 100 in the first site 110 and the destination address of the second station 500 in the second site 510. Device 400 keeps its association of the current connection between the two stations and the selected tunnel as indicated by the tunnel and station addresses.

Tables 3, 4, and 5, provided below, show the local station table, remote station table, and connection table associated with device 400. The connection table of Table 5 holds the new association of the connection between station 100 to station 500 and the selected tunnel 310 (of FIG. 6).

TABLE 3
LOCAL STATION TABLE

| Station | Tunnel | Tunnel Address |
|---|---|---|
| 5.1.1.1 | 11 | 300.1.1.1 |
| 5.1.1.1 | 12 | 400.1.1.1 |
| 5.1.1.1 | 21 | 300.1.1.1 |
| 5.1.1.1 | 22 | 400.1.1.1 |

TABLE 4
REMOTE STATION TABLE

| Station | Tunnel | Tunnel Address |
|---|---|---|
| 1.1.1.1 | 12 | 100.1.1.1 |
| 1.1.1.1 | 21 | 200.1.1.1 |
| 1.1.1.1 | 22 | 200.1.1.1 |

TABLE 5
CONNECTION TABLE

| Local Station | Remote Station | Tunnel |
|---|---|---|
| 5.1.1.1 | 1.1.1.1 | 11 |

Next, device 400 of the second site forwards the packet to the second station 500 that is the destination of the original packet. Second station 500 in the second site receives the packet and identifies the sender as the first station in the first site, without any indication that the packet was tunneled.

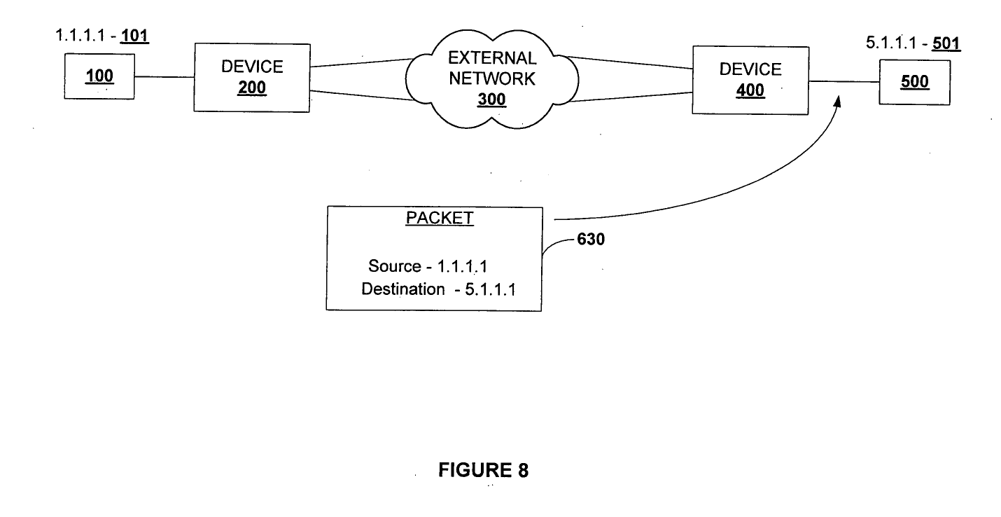

FIG. 8 shows packet 630 transmitted from device 400 to station 500. The source address of the packet is station address 101 (i.e., 1.1.1.1) that represents station 100 and the destination address of the packet is station address 501 (i.e., 5.1.1.1) that represents station 500.

In one embodiment, the remainder of the packets of this connection essentially go through a similar process with one difference. Since the devices are aware of the association between the connection and the selected tunnel for this connection, there is no need to select the tunnel again. The packets go through the same tunnel, which provides persistence of the path of consecutive packets and ensures that packets are transmitted in order and received in order between the stations.

In an alternative embodiment, the devices select different tunnels for the remainder of the packets of the connection, such that messages of a single connection are spread across multiple tunnels. This offers better security and better balancing of the traffic load between the tunnels.

In yet another embodiment, the system and method is provisioned to handle the event of a link failure between a site and the external network. Each device continuously monitors the connectivity over each of its links to the external network to verify whether the links are operational or not. This can be done by checking the physical link connection or by transmitting traffic through the link or receiving traffic through the link. Upon detecting a failure in a link, all the tunnels that this specific link participates in become out-of-service. Then, the device that detects the failure of one of its links reports the information about the failure to all of the devices that have tunnels over this link. Next, all of the devices avoid using these tunnels until a report arrives that the link is operational again.

Each link can have a finite capacity of traffic that can flow through it. When a link is loaded with traffic, there is a possibility that traffic will be dropped by the network. Each device continuously monitors the amount of traffic that is transmitted, or received, over its links to find out whether a link is becoming loaded by traffic. In one embodiment, each link is assigned a “Link Load Weight” that represents its available bandwidth compared to the other links and each link also has a “Link Preference Weight” that is not dependent on the dynamic load and represents the weighted priority of this link compared to the other links that connect to the device.

In another embodiment, each tunnel between two sites supplies a round-trip time and a packet loss ratio for packets that are sent through it. The round-trip time for the packets is a combination of the latency of transmitting traffic from a first site to a second site and the latency of transmitting traffic back from the second site to the first site. Each of the tunnels between the two sites is assigned a “Tunnel Latency Weight” that represents its latency compared to the other tunnels. Each tunnel may have a tunnel preference weight that is not dependent on the dynamic latency and represents a weighted priority of this tunnel compared to other tunnels that connect between the same sites.

Tables 6 and 7, below, show tunnel table and local link table that reflect the optional tunnels and links for selection in a multi-homed tunneling site.

TABLE 6
TUNNEL TABLE

| Tunnel | Local Link | Remote Link | Latency | Preference |
|---|---|---|---|---|
| 11 | 1 | 1 | 500 | 35 |
| 12 | 1 | 2 | 400 | 60 |
| 21 | 2 | 1 | 800 | 40 |
| 22 | 2 | 2 | 100 | 80 |

TABLE 7
LOCAL LINK TABLE

| Link | Status | Load | Preference |
|---|---|---|---|
| 1 | Operational | 80 | 50 |
| 2 | Operational | 40 | 60 |

In order to make a decision about tunnel selection for a new connection, a device considers the multiple optional tunnels between the sites where the two communicating stations reside. The decision involves the status of the links that comprise the tunnel, the Link Load Weight and the Link Preference Weight of each of the links that comprise the tunnel, and the Tunnel Latency Weight and Tunnel Preference Weight of the tunnel. Each potential tunnel is evaluated by a combination of these parameters (or part of them) and the best fit tunnel is selected to pass the traffic for this session.

Provided below in an example function for tunnel selection:

1. Let the Priority of a Link be:

P(link)=Link-load-weight*current-link-load+Link-preference-weight*link-preference

2. Let the priority of a tunnel be:

P(tunnel)=Tunnel-latency-weight*current-latency+Tunnel-preference-weight*tunnel-preference 3. Let the overall tunnel selection grade be:

G(tunnel)=Local-link-status*Remote-link-status*(P(local-link)+P(remote-link)+P(tunnel)

In the above mentioned example, a link-status is considered 0 when the link is down, or when the link is fully loaded. Furthermore, when the tunnel's grade is 0, the tunnel is not selected, otherwise, the tunnel with the lowest grade is chosen.

The sites communicate amongst themselves to update each other about the status of the links in each site. Through a Tunneling Report Protocol communication, each device receives information of the available services that operate in each of the other sites. The information includes information regarding the stations available for each service, their addresses, and their tunnel addresses in that site. The information also includes the available links of each site and their current load. To get this information, a device in a single site has to be aware of the devices in other sites, either by their IP address or their DNS name, and the password for each device to make the communication secure.

Furthermore, the present invention includes a computer program code based product, which is a storage medium having program code stored therein which can be used to instruct a computer to perform any of the methods associated with the present invention. The computer storage medium includes any of, but not limited to, the following: CD-ROM, DVD, magnetic tape, optical disc, hard drive, floppy disk, ferroelectric memory, flash memory, ferromagnetic memory, optical storage, charge coupled devices, magnetic or optical cards, smart cards, EEPROM, EPROM, RAM, ROM, DRAM, SRAM, SDRAM, and/or any other appropriate static or dynamic memory or data storage devices.

Implemented in computer program code based products are software modules for: (a) aiding in the reception of a first packet among a plurality of packets from a first station, wherein the first packet identifies, as a source address, the first station address, and identifies, as a destination address, the second station address; (b) selecting, for transmission of the packet, a tunnel among a plurality of available tunnels between the first and second site, each of the tunnels formed between a single link in the first site and a single link in the second site; (c) based on the selected tunnel in (b), identifying a source tunnel address associated with the source address and identifying a destination tunnel address associated with the destination address; (d) modifying the packet by replacing the source address and the destination address of the packet with the source tunnel address and destination tunnel address respectively; (e) aiding in the transmission of the modified packet through a link corresponding to the selected tunnel; and (f) repeating steps (a)-(e) for transmitting each packet in remainder the packets.

As the traffic between the first station and the second station is bi-directional, the present invention's method also encompasses the flow of data from the tunnels to a multi-homing tunneling device associated with the first site. Hence, also implemented in computer program code based products are software modules for: (a) receiving a packet over a link, wherein the destination address is a tunnel address of the first site and the source address is a tunnel address of the second site; (b) identifying an address of a first station in the first site and an address of a second station in the second site, both associated with the tunnel addresses of the packet; (c) modifying the packet by replacing the destination address and the source address of the packet with the address of the first station and second station respectively; and (d) transmitting the modified packet to the first station.

### CONCLUSION

A system and method has been shown in the above embodiments for the effective implementation of multi-link tunneling. While various preferred embodiments have been shown and described, it will be understood that there is no intent to limit the invention by such disclosure, but rather, it is intended to cover all modifications and alternate constructions falling within the spirit and scope of the invention, as defined in the appended claims. For example, the present invention should not be limited by specific IP addresses, type of services, number of workstations operating under a device, type of protocol used by multi-homing tunneling devices to communicate with each other, type and number of external networks over which data is transmitted, software/program, computing environment, or specific computing hardware.

The above enhancements are implemented in various computing environments. For example, the present invention may be implemented on a conventional, multi-nodal system (e.g., LAN, WAN, MAN) or networking system (e.g., Internet, WWW, wireless web, cellular). All programming and data related thereto are stored in computer memory, static or dynamic, and may be retrieved by the user in any of: conventional computer storage, display (i.e., CRT) and/or hardcopy (i.e., printed) formats. The programming of the present invention may be implemented by one of skill in the art of network communications.

1. A method, implemented in a multi-homing tunneling device associated with a first site, to collect availability and latency information via polling a remote device at a second site over one or more tunnels, said method comprising the steps of:
(a) creating a tunnel between a single link in said first site and a single link in said second site;
(b) generating packet-based traffic and polling said remote device with said generated traffic over said created tunnel; and
(c) based upon said polling, verifying functionality of said created tunnel, determining at least one of the following: a round trip time associated with transmission of packets or a packet loss ratio between transmitted packets and received packets.

2. A method as per claim 1, wherein transmissions from said multi-homing device to said remote device comprise the steps of:
(a) for each packet to be transmitted, identifying a source tunnel address corresponding to a source address of said packet and identifying a destination tunnel address corresponding to a destination address of said packet;
(b) modifying said packet by replacing said source address and said destination address of said packet with said source tunnel address and destination tunnel address respectively; and
(c) transmitting said modified packet through said created tunnel.

3. A method as per claim 1, wherein reception, in said multi-homing device, of packetized data transmitted by said remote device comprises the steps of:
(a) receiving a packet over said created tunnel, wherein said packet's destination address is a destination tunnel address of said first site and said packet's source address is a source tunnel address of said second site;
(b) identifying an internal network address of an intended recipient first station corresponding to said destination tunnel address and an internal network address of a second station in said second site corresponding to said source tunnel address;
(c) modifying said packet by replacing said destination address and said source address of said packet with said identified internal network addresses of said first station and second station respectively; and
(d) transmitting the modified packet to said intended recipient.

4. A method, implemented in a multi-homing tunneling device associated with at least one station in a first site, facilitating tunnel-based packetized communication transmission from a first station in said first site to a second station in a second site via one or more links communicating over one or more networks, said first station having a first station address associated with an internal network of said first site and said second station having a second station address associated with an internal network of said second site, said method comprising the steps of:
(a) receiving a packet from said first station, said packet identifying said first station address as a source address and identifying said second station address as a destination address;
(b) selecting, for transmission of said packet, a tunnel among a plurality of available tunnels between the first and second site, each of said tunnels formed between a single link in said first site and a single link in said second site;
(c) based on said selected tunnel in (b), identifying a source tunnel address associated with said source address and identifying a destination tunnel address associated with said destination address;
(d) modifying said packet by replacing said source address and said destination address of said packet with said source tunnel address and destination tunnel address respectively; and
(e) transmitting said modified packet through a link corresponding to said selected tunnel.

5. A method as per claim 4, wherein additional packets between said first and second stations, are transmitted via said selected tunnel used to transmit said first packet.

6. A method as per clam 4, wherein additional packets between said first and second stations, are transmitted via said plurality of available tunnels.

7. A method as per claim 4, wherein said source tunnel address and destination tunnel address are at least partially composed from any of the following: an IP address value, a TCP port number, a UDP port number, an IP protocol header field, an Ethernet tag, and a MPLS tag value.

8. A method as per claim 4, wherein said method additionally comprises the step of monitoring and identifying link failure in links associated with each site, and upon identification of such a failed link, instructing a device associated with said failed link to exclude said failed link and tunnels associated with said failed link in future communication sessions.

9. A method as per claim 4, wherein said links associated with a tunnel are monitored for traffic overload and tunnels with overloaded links are avoided in selection step (b).

10. A method as per claim 4, wherein each link is assigned a link load weight identifying available bandwidth, said link load weight used in selection step (b).

11. A method as per claim 4, wherein each link is assigned a link preference weight identifying relative priority among available links, said link preference weight used in selection step (b).

12. A method as per claim 4, wherein each tunnel between two sites is assigned a tunnel latency weight representing at least one of the following values: a round trip time value or a packet loss ratio value associated with a tunnel compared to a remainder of tunnels, said tunnel latency weight used in selection step (b).

13. A method as per claim 4, wherein each tunnel between two sites is assigned a tunnel preference weight identifying relative preference among available tunnels, said tunnel preference weight used in selection step (b).

14. A method as per claim 4, wherein said devices exchange information regarding interfaces, thereby allowing each device to maintain a local station table with information regarding interfaces within a local network and a remote station table with information regarding interfaces located on remote networks.

15. A method as per claim 4, wherein said networks is any of the following: local area network (LAN), wide area network (WAN), metropolitan area network (MAN), wireless network, cellular network, or the Internet.

16. A method, implemented in a multi-homing tunneling device associated with at least a first station in a first site, facilitating the reception of tunnel-based packetized communications from a second station in a second site via one or more links communicating over one or more networks, said method comprising the steps of:
(a) receiving a packet over a link among said one or more links, wherein said packet's destination address is a destination tunnel address of said first site and said packet's source address is a source tunnel address of the second site;
(b) identifying an internal network address of said first station corresponding to said destination tunnel address and an internal network address of said second station corresponding to said source tunnel address;
(c) modifying said packet by replacing said destination address and said source address of said packet with said identified internal network addresses of said first station and second station respectively; and
(d) transmitting the modified packet to said first station.

17. An article of manufacture comprising a computer usable medium having computer readable program code embodied therein implementing a multi-homing tunneling device associated with at least one station in a first site, said medium facilitating tunnel-based packetized communication transmission from a first station in said first site to a second station in a second site via one or more links communicating over one or more networks, said first station having a first station address associated with an internal network of said first site and said second station having a second station address associated with an internal network of said second site, said method comprising the steps of:
(a) computer readable program code aiding in receiving a packet from said first station, said packet identifying, as a source address, said first station address, and identifying, as a destination address, said second station address;
(b) computer readable program code selecting, for transmission of said packet, a tunnel among a plurality of available tunnels between the first and second site, each of said tunnels formed between a single link in said first site and a single link in said second site;
(c) based on said selected tunnel in (b), computer readable program code identifying a source tunnel address associated with said source address and identifying a destination tunnel address associated with said destination address;
(d) computer readable program code modifying said packet by replacing said source address and said destination address of said packet with said source tunnel address and destination tunnel address respectively; and
(e) computer readable program code aiding in transmitting said modified packet through a link corresponding to said selected tunnel.

18. A multi-homing tunneling device located at a first site facilitating tunnel-based packetized communication transmission between a first station in said first site and a second station in a second site, said communication performed over one or more external networks, said device comprising:
a first interface operatively linking said device with at least one station in said first site;
a second interface operatively linking said device with said one or more external networks via a plurality of links, said device able to communicate, over said external networks, with at least one station on a second site via a plurality of tunnels, each of said tunnels formed between a single link in said first site and a single link in said second site;
memory for storing network information associated with said tunnels and said stations; and
wherein said multi-homing tunneling device receives packets, via said first interface, for transmission from a station in said first site, identifies available tunnels in said memory for transmitting said received packets, modifies received packets based upon said identified tunnels, and transmits, via said second interface, said modified packets over said external networks to destination stations.

19. A multi-homing tunneling device as per claim 18, wherein said packets are transmitted via a single tunnel.

20. A multi-homing tunneling device as per clam 18, wherein said packets are transmitted via a plurality of available tunnels.

21. A multi-homing tunneling device as per claim 18, wherein said device additionally monitors and identifies link failure in links associated with each site, and upon identification of such a failed link, instructs a device associated with said failed link to exclude said failed link and tunnels associated with said failed link in future communication sessions.

22. A multi-homing tunneling device as per claim 18, wherein said device additionally monitors said links associated with a tunnel for traffic overload, whereby tunnels with overloaded links are avoided in transmission of packets.

23. A multi-homing tunneling device as per claim 18, wherein each link is assigned a link load weight identifying available bandwidth, said link load weight used in selecting links to be used in transmission of packets.

24. A multi-homing tunneling device as per claim 18, wherein each link is assigned a link preference weight identifying relative priority among available links, said link preference weight used in selecting links to be used in transmission of packets.

25. A multi-homing tunneling device as per claim 18, wherein each tunnel is assigned a tunnel latency weight representing at least one of the following values: a round trip time value or a packet loss ratio value associated with a tunnel compared to a remainder of tunnels, said tunnel latency weight used in selecting tunnels to be used in transmission of packets.

26. A multi-homing tunneling device as per claim 18, wherein each tunnel is assigned a tunnel preference weight identifying relative preference among available tunnels, said tunnel preference weight used in selecting tunnels to be used in transmission of packets.

27. A multi-homing tunneling device as per claim 18, wherein said networks element is any of the following: local area network (LAN), wide area network (WAN), metropolitan area network (MAN), wireless network, cellular network, or the Internet.

28. A multi-homing tunneling device located at a first site facilitating tunnel-based packetized communication between at least a first station in said first site and at least a second station in a second site, said communication performed over one or more external networks, said device comprising:
a first interface operatively linking said device with at least one station in said first site;
a second interface operatively linking said device with said one or more external networks via one or more links, said device able to communicate, over said external networks, with at least one station on a second site via a plurality of tunnels, each of said tunnels formed between a single link in said first site and a single link in said second site;
memory for storing network information associated with said tunnels and said stations; and
wherein said multi-homing tunneling device (a) receives a packet via said second interface over said one or more links, wherein said packet's destination address is a destination tunnel address of said first site and said packet's source address is a source tunnel address of said second site; (b) identifies, from said memory, an internal network address of said first station corresponding to said destination tunnel address and an internal network address of said second station corresponding to said source tunnel address, (c) modifies the packet by replacing the destination address and the source address of the packet with the address of the first station and second station respectively, and (d) transmits the modified packet to the first station.

29. A multi-homing tunneling device as per claim 28, wherein each tunnel is assigned a tunnel latency weight representing at least one of the following values: a round trip time value or a packet loss ratio value associated with a tunnel compared to a remainder of tunnels, said tunnel latency weight used in selecting tunnels to be used in transmission of packets.

30. A multi-homing tunneling device as per claim 28, wherein each tunnel is assigned a tunnel preference weight identifying relative preference among available tunnels, said tunnel preference weight used in selecting tunnels to be used in transmission of packets.
